(19) United States
(12) Patent Application Publication
(10) Pub. No.: US 2026/0239206 A1
(43) Pub. Date: Aug. 13, 2026

(54) UE WUR Reporting, Reconfiguration, and Fallback

(71) Applicant: Telefonaktiebolaget LM Ericsson (publ), Stockholm (SE)

(72) Inventors: Andreas Höglund, Solna (SE); Chunhui Zhang, Stockholm (SE); Mohammad Mozaffari, Fremont, CA (US); Yanpeng Yang, Järfälla (SE)

(21) Appl. No.: 19/152,535

(22) PCT Filed: Feb. 7, 2024
(86) PCT No.: PCT/SE2024/050110

§ 371 Date: Jul. 31, 2025

Related U.S. Application Data
(60) Provisional application No. 63/446,624, filed on Feb. 17, 2023.

(51) Int. Cl. H04W 52/02; H04B 17/318; H04W 68/02; H04W 74/0833; H04W 76/28

(52) U.S. Cl. CPC H04W 52/0235; H04B 17/328; H04W 68/02; H04W 74/0833; H04W 76/28

(57) ABSTRACT

A wake up receiver (WUR), also known as a wake up radio, is a low power receiver in a user equipment (UE) that monitors for a wake up signal (WUS) and wakes a main receiver in the UE when a downlink transmission for the UE is expected. The use of a WUR allows the main receiver to remain in a sleep state to save power and can significantly reduce power consumption attributable to WUS monitoring. Techniques are provided to maintain alignment between the network and UE when the UE is configured for WUR-based monitoring.

### TECHNICAL FIELD

The present disclosure relates generally to a wake up receiver (WUR) for low power devices in a wireless communication network and, more particularly, to synchronization of operating modes between a UE and network in scenarios where the UE is capable of WUR-based monitoring.

### BACKGROUND

A wake up receiver (WUR), also known as a wake up radio, is a low power receiver in a user equipment (UE) that monitors for a wake up signal (WUS) and wakes a main receiver in the UE when a downlink transmission for the UE is expected. The use of a WUR allows the main receiver to remain in a sleep state to save power and can significantly reduce power consumption attributable to WUS monitoring, which is particularly important for many use cases in Fifth Generation (5G) networks.

The network may use a different WUS or different time offset for WUR-based monitoring compared to legacy WUS monitoring. Because time is needed to wake the main receiver, the gap or time offset between the WUS and the anticipated transmission to the UE (e.g., paging occasion (PO)) needs to be longer. Also, use of a different WUS with simple modulation and detection techniques is being considered. In cases where a UE is capable of both legacy WUS monitoring and WUR-based monitoring, there is a problem maintaining state synchronization between the UE and network. That is, the network may transmit a WUS according to legacy procedures while the UE is using WUR-based monitoring, or vice versa. In this case, the UE may miss the WUS, which leads to unnecessary power consumption.

### SUMMARY

The present disclosure relates to techniques to avoid or correct for misalignment or state mismatch between a UE and the network in the case where the UE is capable of WUR-based monitoring.

A first aspect of the disclosure comprises methods of WUR reporting implemented by a UE. The UE receives a wake up signal (WUS) associated with a paging attempt from a network node. Responsive to the paging attempt, the UE sends WUR information to the network node, the WUR information comprising information related to WUR-based monitoring by the UE.

A second aspect of the disclosure comprises a UE capable of WUR-based monitoring. The UE is configured to receive a wake up signal (WUS) associated with a paging attempt from a network node. The UE is further configured to, responsive to the paging attempt, the UE sends WUR information to the network node, the WUR information comprising information related to WUR-based monitoring by the UE.

A third aspect of the disclosure comprises a UE capable of WUR-based monitoring. The UE comprises communication circuitry for communicating with a network node in a wireless communication network and processing circuitry operatively connected to the communication circuitry. The processing circuitry being configured to receive a wake up signal (WUS) associated with a paging attempt from a network node. The processing circuitry is further configured to, responsive to the paging attempt, the UE sends WUR information to the network node, the WUR information comprising information related to WUR-based monitoring by the UE.

A fourth aspect of the disclosure comprises a computer program for a UE in a wireless communication system. The computer program comprises executable instructions that, when executed by processing circuitry in the UE, causes the radio node to perform the method according to the first aspect.

A fifth aspect of the disclosure comprises a carrier containing a computer program according to the fourth aspect. The carrier is one of an electronic signal, optical signal, radio signal, or a non-transitory computer readable storage medium.

A sixth aspect of the disclosure comprises methods of configuring WUR-based monitoring implemented by a UE. The UE receives, from a network node, a WUR configuration indicating one or more parameters for WUR-based monitoring. The UE further uses WUR-based monitoring to receive a WUS depending on the WUR configuration.

A seventh aspect of the disclosure comprises a UE configured for WUR reporting. The UE is configured to receive, from a network node, a WUR configuration indicating one or more parameters for WUR-based monitoring. The UE is further configured to use WUR-based monitoring to receive a WUS depending on the WUR configuration.

An eighth aspect of the disclosure comprises a UE configured for WUR reporting. The UE comprises communication circuitry for communicating with a network node in a wireless communication network and processing circuitry operatively connected to the communication circuitry. The processing circuitry being configured to receive, from a network node, a WUR configuration indicating one or more parameters for WUR-based monitoring. The processing circuitry is further configured to use WUR-based monitoring to receive a WUS depending on the WUR configuration.

A ninth aspect of the disclosure comprises a computer program for a UE in a wireless communication system. The computer program comprises executable instructions that, when executed by processing circuitry in the UE, causes the radio node to perform the method according to the sixth aspect.

A tenth aspect of the disclosure comprises a carrier containing a computer program according to the ninth aspect. The carrier is one of an electronic signal, optical signal, radio signal, or a non-transitory computer readable storage medium.

An eleventh aspect of the disclosure comprises fallback methods for WUR-based monitoring implemented by a UE. The UE configures a fallback condition for WUR-based monitoring. Responsive to the fallback condition, switching from WUR-based monitoring to legacy monitoring.

A twelfth aspect of the disclosure comprises a UE capable of WUR-based monitoring. The UE is configured to configure a fallback condition for WUR-based monitoring. The UE is further configured to, responsive to the fallback condition, switch from WUR-based monitoring to legacy monitoring.

A thirteenth aspect of the disclosure comprise a UE capable of WUR-based monitoring. The UE comprises communication circuitry for communicating with a network node in a wireless communication network and processing circuitry operatively connected to the communication circuitry. The processing circuitry being configured to configure a fallback condition for WUR-based monitoring. The processing circuitry is further configured to, responsive to the fallback condition, switch from WUR-based monitoring to legacy monitoring.

A fourteenth aspect of the disclosure comprises a computer program for a UE in a wireless communication system. The computer program comprises executable instructions that, when executed by processing circuitry in the UE, causes the radio node to perform the method according to the eleventh aspect.

A fifteenth aspect of the disclosure comprises a carrier containing a computer program according to the fourteenth aspect. The carrier is one of an electronic signal, optical signal, radio signal, or a non-transitory computer readable storage medium.

A sixteenth aspect of the disclosure comprises methods of WUR reporting implemented by a network node. The network node sends a wake up signal (WUS) associated with a paging attempt to the UE. The network node further receives, from the UE responsive to the paging attempt, WUR information comprising information related to WUR-based monitoring by the UE.

A seventeenth aspect of the disclosure comprises a network node supporting WUR-based monitoring by a UE. The network node is configured to send a wake up signal (WUS) associated with a paging attempt to the UE. The network node is further configured to receive, from the UE responsive to the paging attempt, WUR information comprising information related to WUR-based monitoring by the UE.

An eighteenth aspect of the disclosure comprises a network node supporting WUR-based monitoring by a UE. The network node comprises communication circuitry for communicating with the UE over a wireless communication channel and processing circuitry operatively connected to the communication circuitry. The processing circuitry being configured to send a wake up signal (WUS) associated with a paging attempt to the UE. The network node is further configured to receive, from the UE responsive to the paging attempt, WUR information comprising information related to WUR-based monitoring by the UE.

A nineteenth aspect of the disclosure comprises a computer program for a network node in a wireless communication system. The computer program comprises executable instructions that, when executed by processing circuitry in the network node, causes the radio node to perform the method according to the sixteenth aspect.

A twentieth aspect of the disclosure comprises a carrier containing a computer program according to the nineteenth aspect. The carrier is one of an electronic signal, optical signal, radio signal, or a non-transitory computer readable storage medium.

A twenty-first aspect of the disclosure comprises methods of configuring WUR-based monitoring implemented by a network node. The network node sends, to the UE, a WUR configuration indicating one or more parameters for WUR-based monitoring. The network node further sends a WUS to the UE according to the WUR configuration.

A twenty-second aspect of the disclosure comprises a network node supporting WUR-based monitoring by a UE. The network node is configured to send, to the UE, a WUR configuration indicating one or more parameters for WUR-based monitoring. The network node is further configured to send a WUS to the UE according to the WUR configuration.

A twenty-third aspect of the disclosure comprises a network node supporting WUR-based monitoring by a UE. The network node comprises communication circuitry for communicating with the UE over a wireless communication channel and processing circuitry operatively connected to the communication circuitry. The processing circuitry being configured to send, to the UE, a WUR configuration indicating one or more parameters for WUR-based monitoring. The processing circuitry is further configured to send a WUS to the UE according to the WUR configuration.

A twenty-fourth aspect of the disclosure comprises a computer program for a network node in a wireless communication system. The computer program comprises executable instructions that, when executed by processing circuitry in the network node, causes the radio node to perform the method according to the twenty-first aspect.

A twenty-fifth aspect of the disclosure comprises a carrier containing a computer program according to the twenty-fourth aspect. The carrier is one of an electronic signal, optical signal, radio signal, or a non-transitory computer readable storage medium.

A twenty-sixth aspect of the disclosure comprises fallback methods for WUR-based monitoring implemented by a network node. The network node configures a fallback condition for WUR-based monitoring by the UE. The network node further switches between a WUR-based WUS mode and a legacy monitoring.

A twenty-seventh aspect of the disclosure comprises a network node supporting WUR-based monitoring by a UE. The network node is configured to configure a fallback condition for WUR-based monitoring by the UE. The network node is further is further configured to switch between a WUR-based WUS mode and a legacy monitoring.

A twenty-eighth aspect of the disclosure comprises a network node supporting WUR-based monitoring by a UE. The network node comprises communication circuitry for communicating with the UE over a wireless communication channel and processing circuitry operatively connected to the communication circuitry. The processing circuitry being configured to configure a fallback condition for WUR-based monitoring by the UE. The processing circuitry is further is further configured to switch between a WUR-based WUS mode and a legacy monitoring.

A twenty-ninth aspect of the disclosure comprises a computer program for a network node in a wireless communication system. The computer program comprises executable instructions that, when executed by processing circuitry in the network node, causes the radio node to perform the method according to the twenty-sixth aspect.

A thirtieth aspect of the disclosure comprises a carrier containing a computer program according to the twenty-ninth aspect. The carrier is one of an electronic signal, optical signal, radio signal, or a non-transitory computer readable storage medium.

### BRIEF DESCRIPTION OF THE DRAWINGS

FIG. 1 illustrates a communication network configured to use a WUS.

FIG. 2 illustrates a WUS and paging occasion.

FIG. 3 illustrates a WUS for a UE in a discontinuous reception mode.

FIG. 4 is an illustration of eDRX and DRX WUS gaps for NB-IoT and LTE-M.

FIG. 5 is an illustrates partial WUS coverage in the cell.

FIGS. 6A-6B are examples of a WUR MEDIUM ACCESS CONTROL ELEMENT and an example corresponding parameter table.

FIG. 7 illustrates on example of WUR fallback.

FIG. 8 illustrates a method of WUR reporting implemented by a UE.

FIG. 9 illustrates a method of configuring WUR-based monitoring implemented by a UE.

FIG. 10 illustrates a fallback method for WUR-based monitoring implemented by a UE.

FIG. 11 illustrates a method of WUR reporting implemented by a network node.

FIG. 12 illustrates a method of configuring WUR-based monitoring implemented by a network node.

FIG. 13 illustrates a fallback method for WUR-based monitoring implemented by a network node.

FIG. 14 illustrates a UE configured for WUR-based monitoring.

FIG. 15 illustrates a network node configured for WUR-based monitoring.

FIG. 16 shows an example of a communication system in accordance with some embodiments.

FIG. 17 is a block diagram of a host in accordance with various aspects described herein.

FIG. 18 shows a communication diagram of a host communicating via a network node with a UE over a partially wireless connection in accordance with some embodiments.

### DETAILED DESCRIPTION

Referring now to the drawings, an exemplary embodiment of the present disclosure will be described in the context of Fifth Generation (5G) Next Radio (NR) communication network configured for enhanced Mobile Broadband (eMBB), Ultra Reliable Low Latency Communication (URLLC), and machine Type Communication (MTC) The power saving techniques herein described can be easily adapted by those skilled in the art for use in communication networks based on other radio access technologies (RATs), such as Long Term Evolution (LTE) networks, Wideband Code Division Multiple Access (WCDMA) networks, Code Division Multiple Access (CDMA) 2000 networks, Wireless Fidelity (WiFi) networks, Worldwide Interoperability for Microwave Access (WiMAX) networks, Wireless Local Area Networks (LANs) (WLANs), Narrowband Internet of Things (NB-IoT) networks, Sixth Generation (6G), or other wireless communication networks.

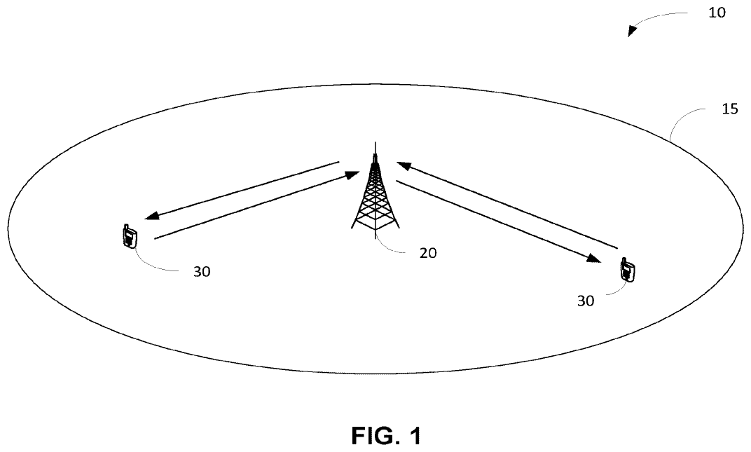

FIG. 1 schematically illustrates a communication network 10 including one or more base stations 20 (only one is shown) providing service in respective cells 15 to user equipment (UEs) 30. The base station 20 is sometimes referred to in applicable standards as an Evolved Node B (eNB) or 5G Node B (gNB). In a split-RAN architecture, the functions of the base station 20 can be split between a distributed unit (DU) implementing the lower layers of the 5G protocol stack (e.g., Physical Layer (PHY). Medium Access Control (MAC) and Radio Resource Control (RRC) and a centralized unit (CU) implementing the higher layers (e.g. Packet Data Convergence protocol). Those skilled in the art will appreciate that other functional splits are also possible,

The UE 30, also referred to as a wireless device or wireless terminal, may comprise a cellular telephone, smart phone, laptop computer, notebook computer, tablet, machine-to-machine (M2M) communication devices (also referred to as machine-type communication (MTC) devices), or other devices capable of communication with a radio access network (RAN) node in the wireless communication network.

The base station 20 transmits information to the UE 30 on downlink (DL) physical channels. A DL physical channel corresponds to a set of REs carrying information originating from higher layers. The DL physical channels currently defined include the Physical Downlink Shared Channel (PDSCH), the Physical Downlink Control Channel (PDCCH) and the Physical Downlink Broadcast Channel (PBCH). The PDSCH is the main physical channel used for DL data transmission, but also for transmission of random access responses (RARs), certain system information blocks (SIBs), and paging information. The PDCCH is used for transmitting downlink control information (DCI), mainly scheduling decisions, required for reception of the PDSCH, and for UL scheduling grants (SGs) enabling transmission on Physical Uplink Shared Channel (PUSCH). The PBCH carries the basic system information (SI) required by the UE 30 to access the network 10.

The base station 20 is responsible for scheduling DL transmissions to the UE 30 on the PDSCH and for allocating resources for the DL transmissions. The base station 20 sends downlink control information (DCI) to the UE 30 on the PDCCH to schedule a DL transmission UE 30. The DCI includes scheduling information such as the allocated resources for the DL transmission and the modulation and coding scheme (MCS).

The UE 30 transmits information to the base station 20 on uplink (UL) physical channels. A UL physical channel corresponds to a set of REs carrying information originating from higher layers. The physical UL channels currently defined include the Physical Uplink Shared Channel (PUSCH), the Physical Uplink Control Channel (PUCCH) and the Physical Random Access Channel (PRACH). The PUSCH is the UL counterpart to the PDSCH. The PUCCH is used by UEs 30 to transmit UL control information (UCI), including Hybrid Automatic Repeat Request (HARQ) acknowledgements, channel state information (CSI) reports, etc. The PRACH is used for random access preamble transmission.

The base station 20 is responsible for scheduling UL transmissions from the UE 30 and for allocating resources for the UL transmissions. After scheduling an UL transmission and allocating resources, the base station 20 sends a scheduling grant (SG) to the UE 30 indicating the resources on which the UE 30 has been scheduled and the transmission format for the scheduled transmission. The UL grant is sent to the UE 30 on the PDCCH. After receiving the UL, the UE 30 determines the UL transmit power for the transmission and transmits data to the base station 20 on the PUSCH resources indicated in the SG.

Radio Resource Control (RRC) is a layer within the 5G NR protocol stack for managing resource utilization. In 5G NR, RRC has three distinct states: RRC_IDLE, RRC_CONNECTED and RRC_INACTIVE. In RRC_CONNECTED, the UE 30 is typically active and radio resources are allocated to the UE 30 for transmitting or receiving data. The UE 30 transitions to the RRC_IDLE state and terminates its RRC connection to the base station 20 when is not otherwise involved in data transmission in order to conserve power and to free up resources for other UEs. In the RRC_IDLE state, the UE receiver enters a low power mode in RRC_IDLE mode and wakes periodically to monitor for a paging message. While releasing an RRC connection in RRC_IDLE state is good for capacity utilization and power saving, it is not ideal from a signaling overhead and latency perspective. For Machine Type Communications (MTC) and IoT applications, that typically send small amounts of data, the overhead for re-establishing the RRC connection is large compared to the amount of data sent. Additionally, the time needed to re-establish the RRC connection increases latency. To reduce latency and signaling overhead for MTC and URLLC use cases, the RRC-INACTIVE state was introduced. In the RRC_INACTIVE state, both the network and the UE 30 save the radio and security configurations so that the UE 30 can re-establish the RRC_CONNECTED state quickly with greatly reduced signaling overhead.

When the UE 30 is in RRC_IDLE state, the UE 30 needs to wake periodically to check for paging messages from the network. Periodically waking the receiver to check for paging messages can lead to waste in energy consumption where the UE 30 is paged infrequently.

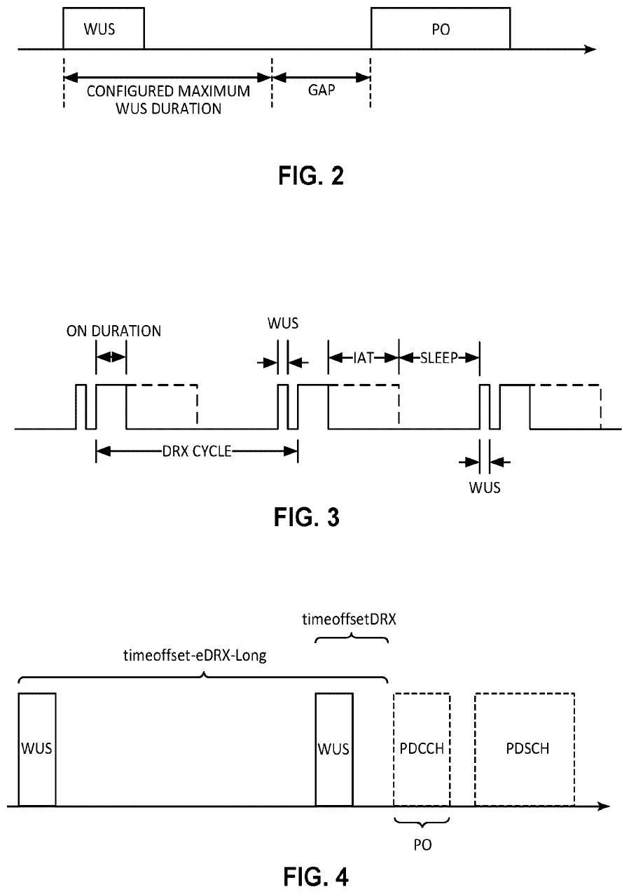

In 3GPP Release 15 (Rel-15), use of a WUS was specified for Narrowband Internet of Things (NB-IoT) and Long-Term Evolution Machine (LTE-M). FIG. 2 illustrates a WUS for NB-IoT and LTE-M. The main motivation was further reduction in energy consumption for the UE to offset higher energy consumption due to coverage enhancement for the PDCCH, which could be repeated many times. The main idea is to send a short WUS at a predetermined time before a paging occasion (PO) as shown in FIG. 2. The UE 30 wakes from a sleep state to receive the WUS and, if the WUS is detected, the UE receiver remains awake to receive the PDCCH. If the WUS is not detected, the UE receiver returns to the low power mode. Power is saved because the WUS is relatively short compared to the PO and hence requires less reception time for the UE. The logic is that a UE 30 would check for a WUS a certain time before its PO, and only if a WUS is detected the UE 30 would continue to check for PDCCH in the PO, and if not, which is most of the time, the UE 30 can go back to a sleep state to conserve energy.

A WUS can also be used when the UE 30 is in a RRC-CONNECTED state. One of the power-consuming activities of a UE 30 in RRC_CONNECTED state is to monitor the PDCCH.

In this state, the UE 30 needs to perform blind detection in its configured control resource sets (CORESETs) to identify whether downlink control information (DCI) is sent to the UE 30 on the PDCCH. On the other hand, the UE 30 is not scheduled in most PDCCH monitoring occasions and thus, the UE 30 monitoring is in almost all cases a waste of energy.

In Release 15, discontinuous reception (DRX) is used to reduce energy consumption. FIG. 3 illustrates DRX operation in simplified form. A DRX cycle is defined by a DRX period and an OnDuration during which the UE 30 100 wakes-up and monitors the PDCCH for DCI addressed to the UE 30 100. If the UE 30 100 detects DCI addressed to the UE 30 100, the UE 30 100 starts an inactivity timer (IAT) and continues to monitor the PDCCH until the inactivity timer expires. The inactivity timer determines the number of consecutive PDCCH-subframe(s) or slots during which the UE 30 100 will remain awake after the subframe or slot in which the PDCCH indicates an initial UL, DL or sidelink (SL) data transmission for the UE 30 100. If the UE 30 100 receives DCI addressed to the UE 30 100, it extends or resets the inactivity timer and continues to monitor the PDCCH. When the inactivity timer expires, the UE 30 100 has the opportunity to sleep until the beginning of the next OnDuration.

Using this DRX technique, the network will only transmit DCI scheduling the UE 30 for a downlink transmission during the OnDuration of the DRX cycle. Therefore, the UE 30 only needs to monitor the PDCCH in those OnDurations and can sleep between the OnDurations in consecutive DRX cycles to save energy. Although DRX reduces energy consumption, DRX still requires the UE 30 to wake-up quite frequently, especially when the length DRX cycle is relatively short. Also, the UE 30 will waste a significant amount of energy when the OnDuration is relatively long with respect to the duration of the DRX cycle.

A WUS can be used to reduce energy consumption when the UE 30 is in the RRC_CONNECTED state. When a WUS is employed, the network will send a WUS to the UE 30 before the start of the next OnDuration of the DRX cycle if it expects to send DCI scheduling a downlink transmission to the UE. When a WUS is implemented, the UE's default behavior is to wake-up and monitor the PDCCH in the next OnDuration of the DRX cycle only when a WUS is detected. If no WUS is detected, the UE 30 remains in a sleep mode during the next OnDuration. The WUS itself will be sent by the network when there is data in the buffer to be transmitted to the UE. By allowing the UE 30 to conduct PDCCH monitoring only when there will be a transmission on the Physical Downlink Shared Channel (PDSCH), the UE 30 energy consumption can be significantly reduced. In addition, WUS monitoring can be set to be more power-efficient compared to that of the normal PDCCH monitoring and thus, improves the UE 30 energy efficiency even further.

A WUS is based on the transmission of a short signal that indicates to the UE 30 that it should continue to decode the DL control channel (e.g., full Narrowband PDCCH (NPDCCH) for NB-IoT). If the WUS is not detected, the UE 30 can go back to sleep without decoding the DL control channel. The decoding time for a WUS is considerably shorter than that of the full Narrowband PDCCH (NPDCCH) since it essentially only needs to contain one bit of information whereas the NPDCCH may contain up to 35 bits of information. This, in turn, reduces UE 30 power consumption and leads to longer UE 30 battery life. The WUS would be transmitted only when there is a paging for the UE. But if there is no paging for the UE 30 then the WUS will not be transmitted and the UE 30 can go back to deep sleep.

WUS was introduced for both LTE-M and NB-IoT with support for both DRX and extended DRX (eDRX), the former with a 1-to-1 mapping between the WUS and the PO and latter with the possible configuration of 1-to-N (many) POs. The base station 20 can configure one WUS gap for UEs using DRX, and another one for UEs using eDRX. The 3GPP Technical Standard (TS) 36.331 gives examples for NB-IoT. LTE-M is similar:

FIG. 4 illustrates use of eDRX and DRX WUS gaps for NB-IoT and LTE-M. Since UEs share PO, the eNB may, in the worst case, have to transmit up to 3 WUSs for one PO. I.e. corresponding to timeoffsetDRX, timeoffset-eDRX-Short, and timeoffset-eDRX-Long. Because UEs can share a PO, the eNB may, in the worst case, have to transmit up to 3 WUSs for one PO. I.e. corresponding to timeoffsetDRX, timeoffset-eDRX-Short, and timeoffset-eDRX-Long.

The UE 30 can report its WUS capability to the network. The UE 30 capabilities can also indicate the minimum WUS gaps required for the UE 30 to be able to decode PDCCH in the associated PO, for DRX and eDRX, respectively See, 3GPP TS 36.331. Further WUS information was added to the paging message/request from mobility management entity (MME) to the base station 20.

The UE-RadioPagingInfo-NB information element (IE) containing use capabilities is shown below.

| UE-RadioPagingInfo-NB-r13 ::= | SEQUENCE { | |
|---|---|---|
| ue-Category-NB-r13 | ENUMERATED {nb1} | OPTIONAL, |

...,

| | | |
|---|---|---|
| [[ multiCarrierPaging-r14 | ENUMERATED {true} | OPTIONAL |

]],

| | | | |
|---|---|---|---|
| [[ | mixedOperationMode-r15 | ENUMERATED {supported} | OPTIONAL, |
| | wakeUpSignal-r15 | ENUMERATED {true} | OPTIONAL, |
| | wakeUpSignalMinGap-eDRX-r15 | ENUMERATED {ms40, ms240, ms1000, ms2000} | OPTIONAL, |
| | multiCarrierPagingTDD-r15 | ENUMERATED {true} | OPTIONAL |

]],

| | | | |
|---|---|---|---|
| [[ | ue-Category-NB-r16 | ENUMERATED {nb2} | OPTIONAL, |
| | groupWakeUpSignal-r16 | ENUMERATED {true} | OPTIONAL, |
| | groupWakeUpSignalAlternation-r16 | ENUMERATED {true} | OPTIONAL |

]]
}

The wakeUpSignalMinGap-eDRX field in the UE-RadioPagingInfo-NB information IE indicates the minimum gap the UE 30 supports between WUS or GWUS and associated PO in case of eDRX.

The base station 20 will use WUS for paging the UE 30 if: 1) WUS is enabled in the cell (i.e., WUS-Config-NB present in System Information (SI)), and 2) the UE 30 supports WUS according to the wakeUpSignal-r15 IE in the UE-RadioPagingInfo-NB information element (IE). The WUS-Config-NB IE is shown below.

| WUS-Config-NB-r15 ::= | SEQUENCE { | |
|---|---|---|
| maxDurationFactor-r15 | WUS-MaxDurationFactor-NB-r15, | |
| numPOs-r15 | ENUMERATED {n1, n2, n4} | DEFAULT n1, |
| numDRX-CyclesRelaxed-r15 | ENUMERATED {n1, n2, n4, n8}, | |
| timeOffsetDRX-r15 | ENUMERATED {ms40, ms80, ms160, ms240}, | |
| timeOffset-eDRX-Short-r15 | ENUMERATED {ms40, ms80, ms160, ms240}, | |
| timeOffset-eDRX-Long-r15 | ENUMERATED {ms 1000, ms2000} | OPTIONAL, -- Need OP |

...
}

| | |
|---|---|
| WUS-ConfigPerCarrier-NB-r15 ::= | SEQUENCE { |
| maxDurationFactor-r15 | WUS-MaxDurationFactor-NB-r15 |

}

| | |
|---|---|
| WUS-MaxDurationFactor-NB-r15 ::= | ENUMERATED {one128th, one64th, one32th, one16th, |
| | oneEighth, oneQuarter, oneHalf} |

The timeOffsetDRX field indicates the non-zero gap, when DRX is used, from the end of the configured maximum WUS duration to the associated PO. The timeOffset-eDRX-Short field indicates the non-zero gap, when eDRX is used, from the end of the configured maximum WUS duration to the associated PO. The network configures timeOffset-eDRX-Short to a value longer than or equal to timeOffsetDRX. The timeOffset-eDRX-Long field indicates the non-zero gap, when eDRX is used, from the end of the configured maximum WUS duration to the associated PO.

Paging with WUS is only used in the cell in which the UE 30 most recently entered RRC_IDLE triggered by reception of RRCEarlyDataComplete, reception of RRCConnectionRelease not including noLastCellUpdate, or reception of RRCConnectionRelease including noLastCellUpdate and the UE 30 was using WUS in this cell prior to this RRC connection attempt. If the UE 30 is in RRC_IDLE, and the UE 30 supports WUS and WUS configuration is provided in SI, the UE 30 monitors WUS using the WUS parameters provided in SI. When DRX is used and the UE 30 detects WUS, the UE 30 monitors the following PO. When extended DRX is used and the UE 30 detects WUS, the UE 30 monitors the following numPOs (where numPOs=Number of consecutive Paging Occasions (PO) mapped to one WUS provided in system information where (numPOs≥1)) POs or until a paging message including the UE's non-access stratum (NAS) identity is received, whichever is earlier. If the UE 30 does not detect WUS, the UE 30 is not required to monitor the following PO(s). If the UE 30 missed a WUS occasion (e.g., due to cell reselection), it monitors every PO until the start of next WUS or until the PTW ends, whichever is earlier.

The WUS configuration, provided in SI, includes time-offset between end of WUS and start of the first PO of the numPOs POs UE 30 is required to monitor. The timeoffset in subframes, used to calculate the start of a subframe g0 (see TS 36.213 [6]), is:
for UE 30 using DRX, it is the signalled timeoffsetDRX;
for UE 30 using eDRX, it is the signalled timeoffset-eDRX-Short if timeoffset-eDRX-Long is not broadcasted;
for UE 30 using eDRX, it is the value determined according to Table 1 below if timeoffset-eDRX-Long is broadcasted.

In practice, the UE 30 will only use WUR, or timeOffset-eDRX-Long, if it is capable of starting up the main receiver as quickly as indicated by the value used in SI. If not, it will fall back to using timeOffset-eDRX-Short (without WUR).

TABLE 1
Determination of gap Between End of WUS and Associated PO

| | | timeoffset-eDRX-Long | |
|---|---|---|---|
| | | 1000 ms | 2000 ms |
| UE 30 Reported | 40 ms | timeoffset-eDRX-Short | timeoffset-eDRX-Short |
| wakeUpSignalMinGap- | or not | | |
| eDRX | reported | | |
| | 240 ms | timeoffset-eDRX-Short | timeoffset-eDRX-Short |
| | 1000 ms | timeoffset-eDRX-Long | timeoffset-eDRX-Long |
| | 2000 ms | timeoffset-eDRX-Short | timeoffset-eDRX-Long |

The timeoffset is used to determine the actual subframe g0 as follows (taking into consideration resultant System Frame Number (SFN) and/or Hyper-SFN (H-SFN) wrap-around of this computation) is given by:

$$g 0 = P O - timeoffset , where PO is the Paging Occasion subframe$$

For UE 30 using eDRX, the same timeoffset applies between the end of WUS and associated first PO of the numPOs POs for all the WUS occurrences for a PTW. The timeoffset, g0, is used to calculate the start of the WUS as defined in 3GPP TS 36.213.

In the 3GPP Release 16 (Rel-16), it was agreed that WUS should be further developed to also include UE 30 grouping, such that the number of UEs that are triggered by a WUS is further narrowed down to a smaller subset of the UEs that are associated with a specific PO. The objective is to specify improvements for machine-type communications for bandwidth reduced low complexity/coverage enhancement (BL/CE) UEs. The improved DL transmission efficiency and/or UE 30 power consumption included specifying support for UE-group wake-up signal (GWUS).

The purpose of these improvements is to reduce the false paging rate, i.e. avoid that a given UE 30 is unnecessarily woken up by a WUS transmission intended for another UE. This feature is referred to as Rel-16 group WUS, or group wake-up signaling (GWUS). However, this is not directly related to WUR and will not further be explained here.

In 3GPP Release 17 (Rel-17) discussions started on introducing a WUS for NR, then called ‘Paging Early Indication’ (PEI). Because no coverage enhancement was specified for NR at that time, the only gain for Rel-17 PEI was in scenarios where the small fraction of UEs are in bad coverage and with large synchronization error due to the use of longer DRX cycles. The gain for such UEs were that with the use of PEI they would typically only have to acquire one synchronization signal block (SSB) before decoding PEI, instead of up to 3 SSBs if PEI is not used (value according to UE 30 vendors). So, for must UEs, Rel-17 PEI will result in gains or increased performance. Rel-17 PEI will also support UE 30 grouping for false paging reduction, similar to the Rel-16 GWUS, which will have some gains at higher paging load.

In 3GPP Release 18 (Rel-18), there has been interest in introducing a wake-up receiver (WUR) for NR. A WUR, also known as a wake up radio, is a low power receiver in UE 30 that monitors for the WUS and wakes a main receiver in the UE 30 when a downlink transmission for the UE 30 is expected. The use of a WUR allows the main receiver to remain in a sleep state to save power and can significantly reduce power consumption attributable to WUS monitoring, which is particularly important for many use case in 5G networks.

To enable use of a WUR, the time gap between the WUS and the PDCCH in the PO needs to be long enough to allow the UE 30 to start up the main receiver. This time gap will typically be longer than the time gap for a UE 30 that does not use a WUR. To enable a simpler and low power receiver, the WUS receiver is implemented with a simpler modulation (e.g. on-off keying (OOK) and detection, and the WUS is not transmitted don the PDCCH.

The benefit of WUR is to reduce the energy consumption of the receiver, such that unless there is any paging and data for the UE, it can remain in a power saving state. This will extend the battery life of the device, or alternatively enable shorter downlink latency (shorter DRX) at a fixed battery life. For short-range communication, the WUR power can be low enough (~3 μW) that this can even, in combination with energy harvesting, enable that the WUR is continuously on (i.e. DRX or duty-cycling is not used) without the need for a battery. This can be considered as a key enabler of battery-less devices towards 6G.

A potential drawback of WUR-based monitoring is state mismatch between the UE 30 and network. The network may use a different WUS or different time offset for WUR-based monitoring compared to legacy WUS monitoring. Because time is needed to wake the main receiver, the gap or time offset between the WUS and the anticipated transmission to the UE 30 (e.g., paging occasion (PO)) needs to be longer. Additionally, the WUS for WUR-based monitoring may not be transmitted on the PDCCH. In cases where a UE 30 is capable of both legacy WUS monitoring and WUR-based monitoring, there is a problem maintaining state synchronization between the UE 30 and network. That is, the network may transmit a WUS according to legacy WUS monitoring procedures while the UE 30 is using WUR-based monitoring, or vice versa. In this case, the UE 30 may miss the WUS, which leads to unnecessary power consumption. Additionally, the network may not be able to communicate with the UE.

In Rel-15 WUS for NB-IoT and LTE-M, UE 30 network (UE-NW) misalignment for WUS monitoring is avoided by configuring the base station 20 to transmit WUS when paging the UE 30 if and only if a) a paging message from MME (mobility management entity) indicates the UE 30 supports WUS (in ‘UE 30 radio paging capabilities’), and b) WUS is configured in the cell according to broadcast SI. Secondly, UE 30 the is configured to monitor WUS if and only if it supports WUS and WUS is configured in the cell according to broadcast SI.

For Rel-18 NR low-power (WUR), there are several differences that could have an impact on synchronization. In contrast to WUS for NB-IoT and LTE-M, the UE 30 uses different receivers for the reception of WUS and legacy signals (i.e. PDCCH and PDSCH for paging). When the UE 30 is monitoring for WUS, it would use its wake-up receiver (WUR) and keep the main receiver in a sleep state, which leads to the WUR power saving gains. This could potentially lead to “state mismatch” between the UE 30 and the network and missed paging, i.e. the UE 30 becomes unreachable in the downlink which is a severe problem.

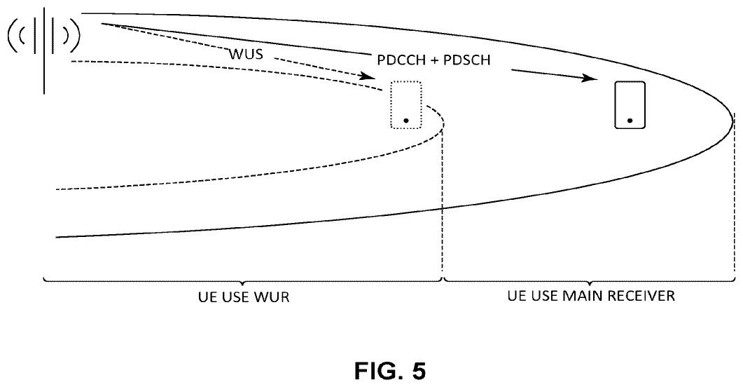

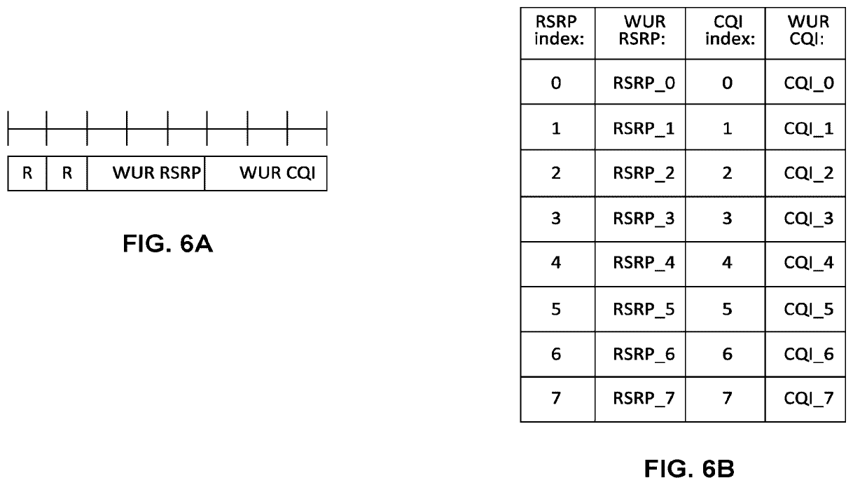

In addition to this, the WUS coverage may be worse that legacy downlink physical channels (PDCCH and PDSCH), so called partial WUS cell coverage, as illustrated in FIG. 5. In this case, the UE 30 would monitor the downlink using WUR whenever it is in sufficiently good coverage (e.g., according to RSRP measurements) and revert to using the main receiver for downlink monitoring when it is not. gNB would also need to send the WUS or legacy paging depending on the UE 30 location in the cell.

Further, two different tracks are currently under investigation by 3GPP. The first track is where the WUS triggers legacy paging reception. In this case, a simple WUS triggers the UE 30 to start up the main receiver and monitor the associated legacy paging. (WUS occasion would typically be associated with the lagging paging frame and paging occasion, e.g., at a defined time offset/gap before it). The second track where the WUS directly triggers random access. In this case, a WUS with a payload can carry a UE 30 identifier so that the UE 30 can directly find out it is being paging and initiate the random access procedure, without the need to continue to monitoring legacy paging procedure since the UE 30 already knows it is being addressed. If this track is adopted, the WUS occasions could be configured freely and do not have to be linked to legacy paging frames and paging occasions.

Considering that WUR has significantly lower complexity compared to the main receiver, it is also more susceptible to false alarms which result in false wake-ups due to noise and interference. Consequently, the main radio might be unnecessarily woken up (while there is no paging or WUS indication) leading to an additional energy consumption.

These differences, and also WUR properties varying between UEs, could also have an impact on when and how it is beneficial to apply WUR operation for a UE. That is, if certain aspects are overlooked WUR coverage and energy saving performance could be suboptimal and even using WUR can result in negative performance impacts.

These differences between WUR-based monitoring and legacy WUS monitoring can lead to different error cases as outlined in Table 2below:

TABLE 2
Error Cases For WUR-Based Monitoring

| | UE 30 in WUS | UE 30 outside WUS |
|---|---|---|
| | coverage | coverage |
| WUS trigger legacy | UE 30 uses WUR, gNB | UE 30 use main receiver, |
| paging monitoring | sends WUS plus legacy | gNB sends legacy paging. |
| (PDCCH + PDSCH) | paging. | Error case 1: UE 30 thinks |
| | Error case 1: UE 30 thinks | it is in WUS coverage and |
| | it is outside WUS | uses WUR → UE 30 |
| | coverage and uses MR → | misses paging [UE 30 |
| | UE 30 misses WUS but | unreachable]. |
| | can receive the | Error case 2: gNB thinks |
| | associated legacy | UE 30 is in WUS coverage |
| | paging [Additional UE 30 | and sends WUS + legacy |
| | energy consumption]. | paging → UE 30 misses |
| | Error case 2: gNB thinks | WUS but can receive the |
| | UE 30 is outside WUS | associated legacy |
| | coverage and sends | paging [unnecessary DL |
| | legacy paging → UE 30 | resource consumption]. |
| | using WUR misses | |
| | paging [UE 30 | |
| | unreachable]. | |
| WUS directly | UE 30 use WUR, gNB | UE 30 use main receiver, |
| trigger RA | sends WUS. | gNB sends legacy paging. |
| | Error case 1: UE 30 thinks | Error case 1: UE 30 thinks |
| | it is outside WUS | it is in WUS coverage and |
| | coverage and use MR → | use WUR → UE 30 |
| | UE 30 misses WUS [UE | misses paging [UE 30 |
| | 30 unreachable + | unreachable]. |
| | Additional UE 30 energy | Error case 2: gNB thinks |
| | consumption]. | UE 30 is in WUS coverage |
| | Error case 2: gNB thinks | and send WUS → UE 30 |
| | UE 30 is outside WUS | misses WUS [UE 30 |
| | coverage and send legacy | unreachable]. |
| | paging → UE 30 misses | |
| | paging [UE 30 | |
| | unreachable]. | |

In summary, the most severe error case is when the UE 30 is outside WUS coverage but incorrectly still using the WUR. In this case, the UE 30 becomes unreachable by gNB and the NW, and unlike the other cases this case cannot be recovered by repeated paging attempts with another approach (e.g., using legacy paging instead of WUS).

One aspect of the disclosure comprises techniques to avoid loss of state synchronization, i.e., avoid state mismatch, between the UE 30 and network where the UE 30 is capable of WUR-based WUS monitoring. These techniques include:
WUR reporting by the UE 30 following a successful paging attempt. The WUR report can include information about WUR use, WUR measurements, and WUR properties, as well as sleep state properties, for optimal configuration and treatment of the UE.
Separating the UE's support for WUR-based monitoring and the actual use of the feature by implementing a new WUR configuration containing rules for determining whether to use WUR or not, under which conditions, and with what optimal configurations.
Providing a fallback mechanisms to ensure the UE 30 does not become unreachable by the network.

The abovementioned techniques are not only beneficial for the UE-NW misalignment in partial WUS coverage but can also be useful for maximizing the WUR gains for the UE.

Advantages of the proposed solution also include avoiding missed paging and unnecessary signal from base station 20 due to UE-NW mismatch and misalignment for the WUS monitoring. Another advantage is more efficient use of WUR to maximize the power saving gain while maintaining the UE 30 coverage in various deployment scenarios. The solutions also provide network flexibility for properly employing WUR based on various requirements such as coverage, energy efficiency, and latency. The techniques can be considered as a key enabler of battery-less (zero-energy) devices and energy harvesting operations towards 5G Advanced and 6G.

### WUR Reporting

In some embodiments, the UE 30 reports its use of WUR to the network responsive to a successful paging attempt. In scenarios where the WUS triggers paging monitoring, the WUR report can be as simple as the UE 30 reporting that uses the WUR to detect WUS or not (since the base station 20 transmits both WUS and [PDCCH+PDSCH]). In this case the UE 30 would typically report results for each successful paging attempt, e.g. in the subsequent random access procedure. The report could be contained in a MAC control element (MAC-CE) or Radio Resource Control (RRC) signaling (e.g., be made part of the self-organizing network (SON) or UE 30 assistance information reporting). More extensive reports could also be useful to the base station 20 and RAN to both correctly configure WUR-based monitoring and to page the UE 30 in the optimal way. Because the WUR and main receiver performance differs (due to differences in sensitivity, noise figure, signal design, etc.), reporting of experienced signal strength and signal quality using WUR is useful for the base station 20 (e.g., WUR RSRP, RSRQ, CQI, SINR). This information would also typically be reported dynamically per each successfully received paging attempt.

In another example, the UE 30 reports its WUR operation mode, which can be duty-cycled operation or always-on operation.

In one example, the WUR information for reporting is introduced as UE 30 Assistance Information (additions bolded and underlined):

UEAssistanceInformation message

```
-- ASN1START
-- TAG-UEASSISTANCEINFORMATION-START
UEAssistanceInformation ::= SEQUENCE {
  criticalExtensions CHOICE {
      ueAssistanceInformation UEAssistanceInformation-IEs,
      criticalExtensionsFuture SEQUENCE { }
  }
}
UEAssistanceInformation-IEs ::= SEQUENCE {
  delayBudgetReport DelayBudgetReport OPTIONAL,
  lateNonCriticalExtension OCTET STRING OPTIONAL,
  nonCriticalExtension UEAssistanceInformation-v1540-IEs OPTIONAL
}
DelayBudgetReport ::= CHOICE {
  type1 ENUMERATED {
                      msMinus1280, msMinus640, msMinus320, msMinus160, msMinus80, msMinus60, msMinus40,
                      msMinus20, ms0, ms20, ms40, ms60, ms80, ms160, ms320, ms640, ms1280},
  ...
}
UEAssistanceInformation-v1540-IEs ::= SEQUENCE {
  overheatingAssistance OverheatingAssistance OPTIONAL,
  nonCriticalExtension UEAssistanceInformation-v1610-IEs OPTIONAL
}
OverheatingAssistance ::= SEQUENCE {
  reducedMaxCCs ReducedMaxCCs-r16 OPTIONAL,
  reducedMaxBW-FR1 ReducedMaxBW-FRx-r16 OPTIONAL,
  reducedMaxBW-FR2 ReducedMaxBW-FRx-r16 OPTIONAL,
  reducedMaxMIMO-LayersFR1 SEQUENCE {
      reducedMIMO-LayersFR1-DL MIMO-LayersDL,
      reducedMIMO-LayersFR1-UL MIMO-LayersUL
  } OPTIONAL,
  reducedMaxMIMO-LayersFR2 SEQUENCE {
      reducedMIMO-LayersFR2-DL MIMO-LayersDL,
      reducedMIMO-LayersFR2-UL MIMO-LayersUL
  } OPTIONAL
}
OverheatingAssistance-r17 ::= SEQUENCE {
  reducedMaxBW-FR2-2-r17 SEQUENCE {
      reducedBW-FR2-2-DL-r17 ReducedAggregatedBandwidth-r17,
      reducedBW-FR2-2-UL-r17 ReducedAggregatedBandwidth-r17
  } OPTIONAL,
  reducedMaxMIMO-LayersFR2-2 SEQUENCE {
      reducedMIMO-LayersFR2-2-DL MIMO-LayersDL,
      reducedMIMO-LayersFR2-2-UL MIMO-LayersUL
  } OPTIONAL
}
ReducedAggregatedBandwidth ::= ENUMERATED {mhz0, mhz10, mhz20, mhz30, mhz40, mhz50, mhz60, mhz80, mhz100, mhz200,
mhz300, mhz400}
ReducedAggregatedBandwidth-r17 ::= ENUMERATED {mhz0, mhz100, mhz200, mhz400, mhz800, mhz1200, mhz1600, mhz2000}
UEAssistanceInformation-v1610-IEs ::= SEQUENCE {
  idc-Assistance-r16 IDC-Assistance-r16 OPTIONAL,
  drx-Preference-r16 DRX-Preference-r16 OPTIONAL,
  maxBW-Preference-r16 MaxBW-Preference-r16 OPTIONAL,
  maxCC-Preference-r16 MaxCC-Preference-r16 OPTIONAL,
  maxMIMO-LayerPreference-r16 MaxMIMO-LayerPreference-r16 OPTIONAL,
  minSchedulingOffsetPreference-r16 MinSchedulingOffsetPreference-r16 OPTIONAL,
  releasePreference-r16 ReleasePreference-r16 OPTIONAL,
  sl-UE-AssistanceInformationNR-r16 SL-UE-AssistanceInformationNR-r16 OPTIONAL,
  referenceTimeInfoPreference-r16 BOOLEAN OPTIONAL,
  nonCriticalExtension UEAssistanceInformation-v1700-IEs OPTIONAL
}
UEAssistanceInformation-v1700-IEs ::= SEQUENCE {
  ul-GapFR2-Preference-r17 UL-GapFR2-Preference-r17 OPTIONAL,
  musim-Assistance-r17 MUSIM-Assistance-r17 OPTIONAL,
  overheatingAssistance-r17 OverheatingAssistance-r17 OPTIONAL,
  maxBW-PreferenceFR2-2-r17 MaxBW-PreferenceFR2-2-r17 OPTIONAL,
  maxMIMO-LayerPreferenceFR2-2-r17 MaxMIMO-LayerPreferenceFR2-2-r17 OPTIONAL,
  minSchedulingOffsetPreferenceExt-r17 MinSchedulingOffsetPreferenceExt-r17 OPTIONAL,
  rlm-MeasRelaxationState-r17 BOOLEAN OPTIONAL,
  bfd-MeasRelaxationState-r17 BIT STRING (SIZE (1..maxNrofServingCells)) OPTIONAL,
  nonSDT-DataIndication-r17 SEQUENCE {
      resumeCause-r17 ResumeCause OPTIONAL
  } OPTIONAL,
  scg-DeactivationPreference-r17 ENUMERATED { scgDeactivationPreferred, noPreference } OPTIONAL,
  uplinkData-r17 ENUMERATED { true } OPTIONAL,
  rrm-MeasRelaxationFulfilment-r17 BOOLEAN OPTIONAL,
  propagationDelayDifference-r17 PropagationDelayDifference-r17 OPTIONAL,
  nonCriticalExtension SEQUENCE { } OPTIONAL
}
UEAssistanceInformation-v18xy-IEs ::= SEQUENCE
    wur-Assistance-r18 WUR-Assistance-r18 OPTIONAL
}
IDC-Assistance-r16 ::= SEQUENCE {
  affectedCarrierFreqList-r16 AffectedCarrierFreqList-r16 OPTIONAL,
  affectedCarrierFreqCombList-r16 AffectedCarrierFreqCombList-r16 OPTIONAL,
  ...
}
< Text omitted >
WUR-Assistance-r18 ::= SEQUENCE {
  preferredMaxDRX-r18 ENUMERATED {
                        ms10, ms20, ms32, ms40, ms60, ms64, ms70, ms80, ms128, ms160, ms256, ms320, ms512, ms640, ms1024, ms1280,
                        ms2048, ms2560,
                                    ms5120, ms10240, spare12, spare11, spare10,spare9, spare8, spare7, spare6, spare5, spare4, spare3,
                                    spare2, spare1 } OPTIONAL,
      minWusGap-r18 ENUMERATED {
                                    ms0, ms1, ms2, ms3, ms4, ms5, ms6, ms8, ms10, ms20, ms30, ms40, ms50, ms60, ms80,ms100, ms200,
                                    ms300, ms500, ms750, ms1280, ms1920, ms2560, spare9, spare8, spare7, spare6, spare5, spare4, spare3,
                                    spare2, spare1} OPTIONAL,
  ...
}
< Text omitted >
-- TAG-UEASSISTANCEINFORMATION-STOP
-- ASN1STOP
```

In one example, the WUR information for reporting is introduced as SON-parameters (additions bolded and underlined):

### SON-Parameters Information Element

```
-- ASN1START
-- TAG-SON-PARAMETERS-START
SON-Parameters-r16 ::=SEQUENCE {
  rach-Report-r16 ENUMERATED {supported} OPTIONAL,
  ...,
  [[
  rlfReportCHO-r17 ENUMERATED {supported} OPTIONAL,
  rlfReportDAPS-r17 ENUMERATED {supported} OPTIONAL,
  success-HO-Report-r17 ENUMERATED {supported} OPTIONAL,
  twoStepRACH-Report-r17 ENUMERATED {supported} OPTIONAL,
  pscell-MHI-Report-r17 ENUMERATED {supported} OPTIONAL,
  onDemandSI-Report-r17 ENUMERATED {supported} OPTIONAL
  ]],
      [[
  WUR-Report-r18 ENUMERATED {supported} OPTIONAL
    ]]
}
-- TAG-SON-PARAMETERS-STOP
-- ASN1STOP
```

In one example, the WUR information for reporting is introduced as MAC control element (additions in bold). So a new LCID can be introduced for the purpose of WUR reporting:

TABLE 6.2.1-2
Values of LCID for UL-SCH

| Codepoint/ | |
|---|---|
| Index | LCID values |
| 0 | CCCH of size 64 bits (referred to as “CCCH1” |
| | in TS 38.331 [5]), except for a RedCap UE |
| 1-32 | Identity of the logical channel of DCCH and DTCH |
| 33 | Extended logical channel ID field |
| | (two-octet eLCID field) |
| 34 | Extended logical channel ID field |
| | (one-octet eLCID field) |
| 35 | CCCH of size 48 bits (referred to as “CCCH” |
| | in TS 38.331 [5]) for a RedCap UE 30 |
| 36 | CCCH of size 64 bits (referred to as “CCCH1” |
| | in TS 38.331 [5]) for a RedCap UE |
| 37-41 [symbol] | Reserved |
| 42 | WUR information |
| 43 | Truncated Enhanced BFR (one octet Cᵢ) |
| 44 | Timing Advance Report |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits (referred to as “CCCH” |
| | in TS 38.331 [5]), except for a RedCap UE |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

Using a MAC CE is typically well suited for more dynamic information. An example of CQI reporting using the WUR is shown in FIGS. 5a and 5b illustrating an example of a WUR MAC-CE and an example Table where 3 bits each are used to report different levels or measure RSRP and CQI.

More static information can be reported by the UE 30 that is relevant for gNB to configure and treat the UE 30 in the best possible way.

The following properties for the UE's WUR are some examples of WUR information that could be reported by the UE 30 to the gNB to configure the UE.

In one example, the WUR information can include WUR performance metrics and/or receiver properties. The WUR performance metrics information can include any of a receiver noise figure, receiver sensitivity, receiver oscillator/clock accuracy (and/or expected sync time required). Other receiver properties can include selectivity, fidelity, stability, image frequency and rejection, double spotting, tracking and alignment, etc. The performance metrics information can include receiver parameters including filter bandwidth, type of filter, analog-to-digital (ADC) parameters, sampling rate. The performance metrics information can also include WUR architecture type, or type of WUR. The performance metrics information can also include WUR performance class according to some defined metrics (e.g. class1, class2, class3, with defined ranges for WUR properties and key performance indicators (KPIs)).

In one example, the WUR information can include WUR power and sleep state related parameters. Sleep state related parameters can include WUR power information including WUR active power, WUR sleep power, WUR transition power and time. The WUR power information may include either absolute value, a reported range or class, or relative value compared to main receiver.

In one example, the WUR information can include the WUR DRX/duty-cycle length at which it is beneficial for UE 30 energy consumption the main receiver to go the ultra-deep sleep state. Similar to the above, but the regular main receiver sleep states, the deep sleep, light sleep, micro sleep, etc., information may be included. A reporting assuming a certain paging probability per time unit (e.g. 0%) can also be included.

In one example, the WUR information can include, radio resource management (RRM) measurement information. The RRM information indicating use of the WUR or main receiver for RRM measurements. The RRM information can also be differentiated for service cell and neighbor cell measurements and/or differentiated for intra- and inter-frequency measurements.

In one example, the information can be an applied WUR Radio Resource management (RRM) measurement periodicity (e.g., if the UE 30 applies performs serving cell measurements only every 8^{th} duty/DRX-cycle instead of in every duty/DRX-cycle). The applied WUR RRM measurement periodicity can be differentiated for service cell and neighbor cell measurements.

In one example, the information may relate to WUR and main receiver interactions. There can be various levels of interaction between WUR and main receiver in terms of information exchange such as time-frequency synchronization and splitting functionalities between them depending on the scenario. If base station 20 is aware of such interactions, the system performance can be further optimized. The main receiver can also periodically check if WUR is properly operational. In case of WUR failure/malfunction, the main receiver can detect this and report to base station.

The WUR information can inform the network about the WUR coverage and/or the WUR energy saving. The base station 20 can use the WUR information to determine when and how WUR should be configured as described in more detail below.

Note that in the case of reporting static information also non-access stratum (NAS) signaling would be an option.

### WUR Configuration Aspects

In some embodiments, the UEs capability for supporting WUR-based WUS monitoring is separate from the configuration and application of WUR-based monitoring for the UE. The UE 30 may be configured with both legacy WUS monitoring and with a separate WUR configuration for WUR-based WUS monitoring for paging. The benefit of this approach is that for certain conditions it may not be beneficial to apply WUR, e.g., if the DRX cycle is longer than a certain value (such that energy savings are insignificant but WUR link performance may be worse), if the start-up time for the main receiver is longer than the DL delay requirement, or if WUS coverage is problematic (see above), or if the UE's paging rate is so high it is paged in the majority of its duty/DRX-cycles.

In a more advanced alternative of this embodiment, it is not only stored if WUR operation is to be applied for the UE, but also conditions are specified for when it should be applied. Some examples are the following:
WUR operation is configured to be applied when Duty/DRX-cycle or DL latency requirement is shorter than X ms. (The rationale being that WUR energy savings will be indistinguishable from legacy DRX or eDRX above a certain cycle length, but link performance and system overhead may be worse).
WUR operations is configured to be applied when Duty/DRX-cycle or DL latency requirement is longer than Z ms. (The rationale being that the DRX cycle length is configured for the UE 30 based on the DL latency requirement but using WUR a latency lower than the start-up time of the main receiver cannot be achieved).
WUR operations is configured to be applied in certain cells (the rationale being limiting. control signaling overhead, false paging, and potential WUS mismatch for mobile UEs). For example, WUR operations may be configured to be applied in the cell in which the UE 30 was configured, or re-configured, with WUR, in the UE's last known cell (i.e., the cell in which the UE 30 last had a connection to the network, i.e., RRC connection), in the UE's RAN Notification Area (i.e., for RAN paging in RRC_INACTIVE), and/or in the UE's UE 30 Registration Area (i.e., for CN paging in RRC_IDLE)
WUR operations is configured to be applied conditionally on coverage.
WUR operations is configured to be applied in cells of lower coverage, e.g., small cell deployments, cells without outdoor-to-indoor wall penetration loss or coverage in basements, etc. (the rationale being worse WUS coverage).
WUR operations is configured to be applied when system control signaling overhead is currently not a concern in the network or cell (i.e., for ‘WUS trigger legacy paging monitoring’, WUR operation will add to the overhead).
WUR operations is activated when there is need for power saving. For example, when the UE 30 battery level falls below a threshold, WUR is used to provide power saving.
WUR operations is configured to be applied WUR can be used in static or low-mobility scenarios and for high-mobility scenarios main radio is used by default to handle mobility-related aspects. For example, WUS is activated if the UE 30 speed is less than threshold V m/s or the position of the UE 30 does not change for a certain duration T seconds.

Access and Mobility Management Function (AMF) (in case of core network paging in RRC_IDLE) or anchor base station 20 (in case of RAN paging in RRC_INACTIVE) could determine if Rel-18 WUS should be used for paging the UE 30 based on the above criteria. In some embodiments, the network determines when WUR-based monitoring is used and signals the UE. IN other embodiments, the UE 30 and network determined whether to use WUR-based reporting autonomously. In this case, the network and the UE 30 must have a common understanding of whether WUS is to be used or not (see discussion on UE-NW mismatch above). For this reason, either explicit signaling could be used to configure the UE 30 to use WUR or not (either by AMF using NAS signaling, or by anchor base station 20 using RRC signaling), or implicitly from some other parameter, e.g., the UE 30 could from the DRX cycle length applied in the cell determine if it should monitor WUS or not in the cell. The configuration could either be done by RAN, e.g., via RRC signaling, and stored as part of the UE 30 context, most naturally in the ‘UE 30 radio paging information’, or it could be done by core network, i.e., NAS configuration negotiated via NAS and the WUR configuration stored in the UE 30 context in AMF.

The WUR reporting from the UE, can be used as input for the network WUR configuration for the UE. In one alternative of this, the UE 30 requirements for WUR operation in the network are not common to all UEs but are made UE-specific, or specific for the WUR class or type the UE 30 reports support for.

### Fallback for WUR-Based Monitoring

It can be beneficial to introduce mechanisms to be able to recover from UE-NW WUS mismatch, e.g., ensuring that a UE 30 outside WUS coverage which incorrectly monitor WUS does not become permanently unreachable.

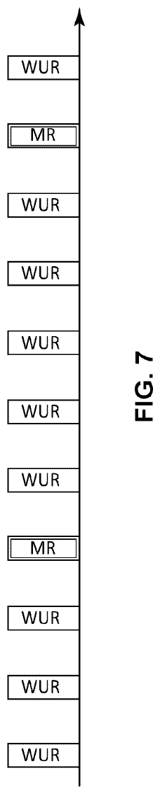

In one embodiment, shown in FIG. 7, the UE 30 falls back to legacy monitoring using the main receiver in a predetermined subset of the WUS monitoring occasions. The legacy monitoring may comprise monitoring of a legacy WUS monitoring or legacy PDCCH monitoring.

In another example, the WUR configuration is valid while a timer T_{WUR} is running, which is started upon configuration and runs both the in the UE 30 and in the NW. At the expiration of the timer, both the UE 30 and network will fall back to legacy monitoring procedure (i.e., not using WUR operation). At an indication from the network to the UE 30 the T_{WUR} timer is restarted. The indication can be sent in DCI, a MAC-CE, RRC signaling, or via NAS signaling, for example.

In another example, a fallback indication is sent from UE 30 to NW under certain conditions. In an alternative embodiment, the NW sends a fallback indication to the UE. The conditions for such fallback indications can be based on, for example, coverage, deployment scenario, latency requirements, mobility, measurements and synchronization aspects, WUR operation, and history of UE 30 reachability (e.g., if UE 30 is not reachable for a certain time, then fallback is indicated). The fallback indications can be sent periodically or in an event-triggered manner.

In some embodiments, the main receiver can be used to occasionally evaluate the coverage. That is, in a certain subset of the WUS monitoring occasions, or at the expiration of a timer, the main receiver performs coverage measurements, for example sing Synchronization Signal Reference Signal Received Power (SS-RSRP) and/or Synchronization Signal Reference Signal Received Quality (SS-RSRQ) measurements. The UE 30 is allowed to use WUR only if the measurements are above certain configured thresholds (part of the WUR configuration). Otherwise, the UE 30 fall backs to legacy monitoring of paging.

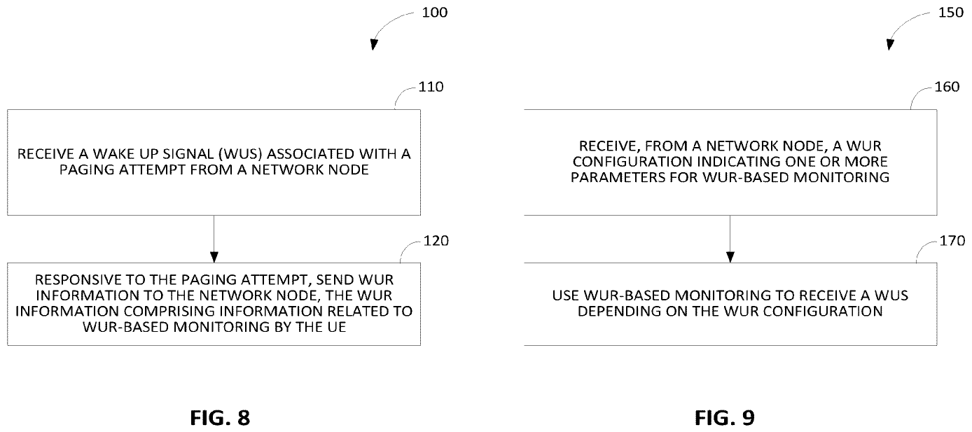

FIG. 8 illustrates a method 100 of WUR reporting implemented by a UE. The UE 30 receives a wake up signal (WUS) associated with a paging attempt from a network node (block 110). Responsive to the paging attempt, the UE 30 sends WUR information to the network node, the WUR information comprising information related to WUR-based monitoring by the UE 30 (block 120)

Some embodiments of the method 100 further comprise monitoring a paging channel responsive to receipt of the WUS.

In some embodiments of the method 100, the WUR information is sent to the network node responsive to successful decoding of a paging message transmitted on the paging channel.

In some embodiments of the method 100, the WUS includes a paging indication to indicate to the network has data to send to the UE.

Some embodiments of the method 100 further comprise initiating a random access procedure responsive to the WUS.

In some embodiments of the method 100, the WUR information is sent to the network node in a Medium Access Control (MAC) Control Element (MAC-CE).

In some embodiments of the method 100, the WUR information is sent to the network node in a Radio Resource Control (RRC) message.

In some embodiments of the method 100, the MAC-CE or RRC message contains a WUR Assistance Information information element containing the WUR information.

In some embodiments of the method 100, the WUR information comprises an indication whether the WUS was received by using the WUR.

In some embodiments of the method 100, the WUR information includes an indication a current WUR operating mode.

In some embodiments of the method 100, the WUR information includes a signal quality of the received WUS.

In some embodiments of the method 100, the signal quality comprises at least one of a WUR reference signal received power (RSRP), a WUR Reference Signal Received Quality (RSRQ), a WUR Channel Quality Indication (CQI), and a WUR Signal to Interference Plus Noise Ratio (SINR).

In some embodiments of the method 100, the WUR information includes one or more performance metrics for the WUR.

In some embodiments of the method 100, the performance metrics comprise at least one of a receiver noise level, a receiver sensitivity, and a receiver clock accuracy.

In some embodiments of the method 100, the WUR information includes one more receiver parameters.

In some embodiments of the method 100, the receiver parameters comprise at least one of a filter bandwidth, filter type, analog-to-digital conversion (ADC) parameter, sampling rate, active power, sleep power, and transition time between power states,

In some embodiments of the method 100, the WUR information includes one or more receiver properties.

In some embodiments of the method 100, the receiver properties comprise at least one of a receiver type and a receiver performance class.

In some embodiments of the method 100, the WUR information includes one or more configuration parameters.

In some embodiments of the method 100, the configuration parameters comprise a discontinuous reception (DRX) parameter.

FIG. 9 illustrates a method 150 of configuring WUR-based monitoring implemented by a UE. The UE 30 receives, from a network node, a WUR configuration indicating one or more parameters for WUR-based monitoring (block 160). The UE 30 further uses WUR-based monitoring to receive a WUS depending on the WUR configuration (block 170).

Some embodiments of the method 150 further comprise sending, to a network node, WUR information indicative of the WUR capabilities, wherein the WUR configuration is based on the WUR information.

In some embodiments of the method 150, the WUR configuration includes one or more of: an activation parameter indicating whether the WUR should be activated; a threshold related to discontinuous reception (DRX) operation, and wherein the WUR is activated when the threshold is met; an indication of one or more cell where the WUR is activated; an indication of one or more cell where the WUR is deactivated; a threshold related to a WUS coverage area; a time parameter for activating or deactivating the WUR; a threshold related to the UE 30 battery level; and a threshold related to UE 30 mobility.

In some embodiments of the method 150, the WUR configuration comprises a minimum DRX cycle length and wherein the WUR is activated when the DRX cycle length is greater than the threshold.

In some embodiments of the method 150, the WUR configuration comprises a maximum DRX cycle length and wherein the WUR is activated when the DRX cycle length is less than the threshold.

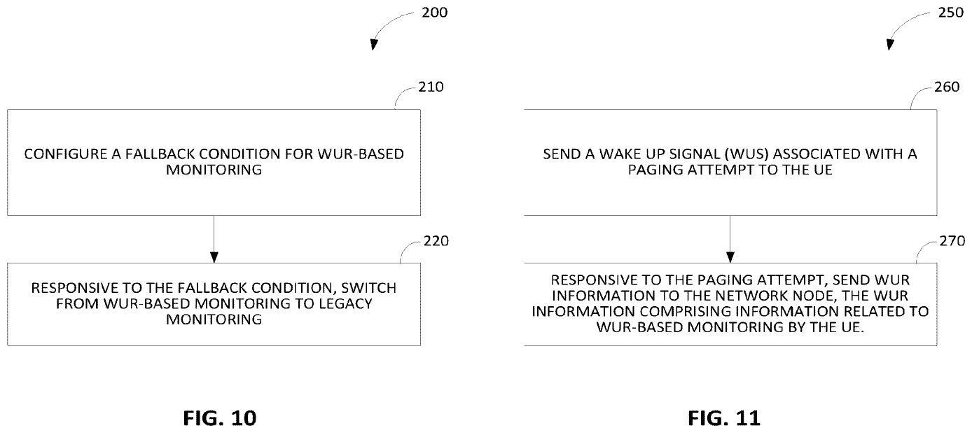

FIG. 10 illustrates a fallback method 200 for WUR-based monitoring implemented by a UE. The UE 30 configures a fallback condition for WUR-based monitoring (block 210). Responsive to the fallback condition, the UE 30 switches from WUR-based monitoring to legacy monitoring (block 220).

In some embodiments of the method 200, the fallback condition comprises expiration of a fallback time.

In some embodiments of the method 200, the fallback timer is started upon configuration or activation of the WUR.

Some embodiments of the method 200 further comprise restarting the fallback timer responsive to receipt of a restart signal from the network node.

In some embodiments of the method 200, the UE 30 is configured to fallback to legacy monitoring in one or more predetermined WUS monitoring occasions.

Some embodiments of the method 200 further comprise performing coverage measurements following fallback to legacy monitoring and switching back to the WUR-based monitoring depending on the coverage measurements.

FIG. 11 illustrates a method 250 of WUR reporting implemented by a network node. The network node sends a wake up signal (WUS) associated with a paging attempt to the UE 30 (block 260). The network node further receives, from the UE 30 responsive to the paging attempt, WUR information comprising information related to WUR-based monitoring by the UE 30 (block 270).

In some embodiments of the method 250, the WUS is sent according to a WUR operating mode.

In some embodiments of the method 250, the WUS includes a paging indication to indicate a paging message for the UE.

In some embodiments of the method 250, a legacy WUS is sent prior to a paging occasion.

Some embodiments of the method 250 further comprise sending a paging message to the UE 30 in the paging occasion.

In some embodiments of the method 250, the WUR information is received from the UE 30 in a Medium Access Control (MAC) Control Element (MAC-CE).

In some embodiments of the method 250, the WUR information is received from the UE 30 in a Radio Resource Control (RRC) message.

In some embodiments of the method 250, the MAC-CE or RRC message contains a WUR Assistance Information information element containing the WUR information.

In some embodiments of the method 250, the WUR information comprises an indication whether the WUS was received by using the WUR.

In some embodiments of the method 250, the WUR information includes an indication a current WUR operating mode.

In some embodiments of the method 250, the WUR information includes a signal quality of the received WUS.

In some embodiments of the method 250, the signal quality comprises at least one of a WUR reference signal received power (RSRP), a WUR Reference Signal Received Quality (RSRQ), a WUR Channel Quality Indication (CQI), and a WUR Signal to Interference Plus Noise Ratio (SINR).

In some embodiments of the method 250, the WUR information includes one or more performance metrics for the WUR.

In some embodiments of the method 250, the performance metrics comprise at least one of a receiver noise level, a receiver sensitivity, and a receiver clock accuracy.

In some embodiments of the method 250, the WUR information includes one more receiver parameters.

In some embodiments of the method 250, the receiver parameters comprise at least one of a filter bandwidth, filter type, analog-to-digital conversion (ADC) parameter, sampling rate, active power, sleep power, and transition time between power states,

In some embodiments of the method 250, the WUR information includes one or more receiver properties.

In some embodiments of the method 250, the receiver properties comprise at least one of a receiver type and a receiver performance class.

In some embodiments of the method 250, the WUR information includes one or more configuration parameters.

In some embodiments of the method 250, the configuration parameters comprise a discontinuous reception (DRX).

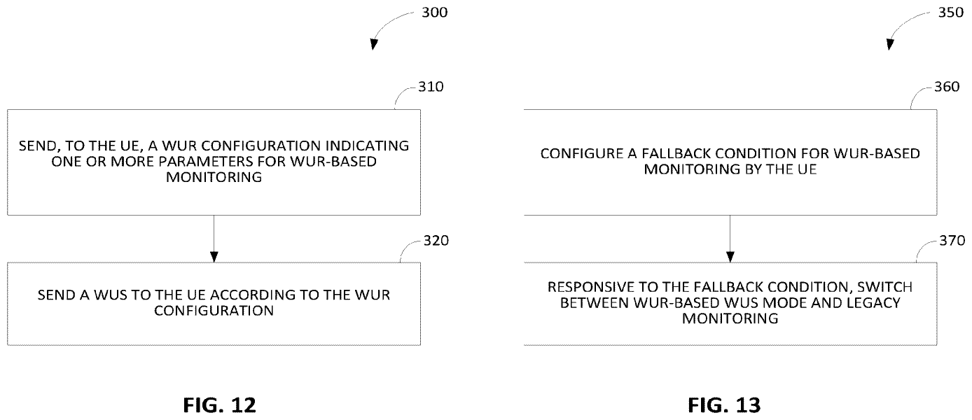

FIG. 12 illustrates a method 300 of configuring WUR-based monitoring implemented by a network node. The network node sending, to the UE, a WUR configuration indicating one or more parameters for WUR-based monitoring (block 310). The network node further sends WUS to the UE 30 according to the WUR configuration (block 320).

Some embodiments of the method 300 further comprise receiving, from the UE, WUR information indicative of the UE's WUR capabilities, wherein the WUR configuration is based on the WUR information.

In some embodiments of the method 300, the WUR configuration includes one or more of: an activation parameter indicating whether the WUR should be activated; a threshold related to discontinuous reception (DRX) operation, and wherein the WUR is activated when the threshold is met; an indication of one or more cell where the WUR is activated; an indication of one or more cell where the WUR is deactivated; a threshold related to a WUS coverage area; a time parameter for activating or deactivating the WUR; a threshold related to the UE 30 battery level; and a threshold related to UE 30 mobility.

In some embodiments of the method 300, the WUR configuration comprises a minimum DRX cycle length and wherein the WUR is activated when the DRX cycle length is greater than the threshold.

In some embodiments of the method 300, the WUR configuration comprises a maximum DRX cycle length and wherein the WUR is activated when the DRX cycle length is less than the threshold.

FIG. 13 illustrates a fallback method 350 for WUR-based monitoring implemented by a network node. The network node configures a fallback condition for WUR-based monitoring by the UE 30 (block 360). The network node further switches between a WUR-based WUS mode and a legacy monitoring (block 370).

In some embodiments of the method 350, the fallback condition comprises expiration of a fallback time.

In some embodiments of the method 350, the fallback timer is started upon configuration or activation of the WUR.

Some embodiments of the method 350 further comprise sending a restart signal to the UE 30 to restart the fallback timer.

In some embodiments of the method 350, the UE 30 is configured to fallback to legacy monitoring in a specified WUS monitoring occasions.

Some embodiments of the method 350 further comprise receiving coverage measurements from the UE 30 following fallback to legacy monitoring and switching from the legacy WUS to the WUR-based WUS depending on the coverage measurements.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

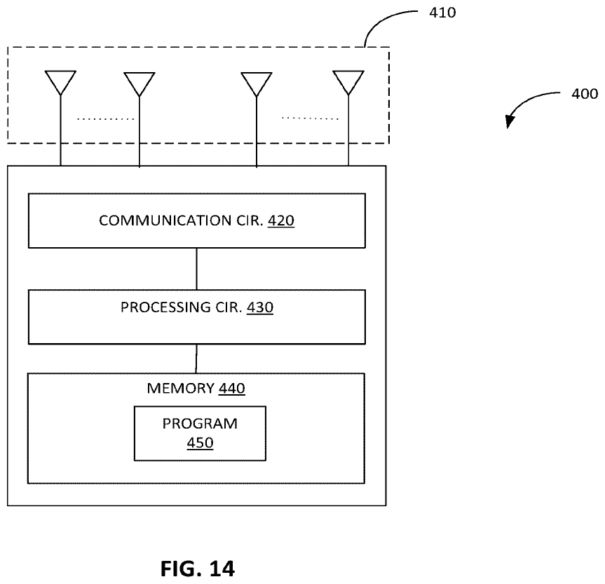

FIG. 14 illustrates the main functional components of a UE 400. The UE 400 comprises one or more antenna panels 410, communication circuitry 420, processing circuitry 430, and memory 440.

Each antenna panel 410 comprises a plurality of antenna elements. The antenna panels 410 may comprise, for example, a phased array antenna. The antenna panels 410 may be arranged to receive signals from different directions. panels

The communication circuitry 420 connects to the antenna panel 410 and comprises radio frequency (RF) circuitry 422 for communicating over a wireless communication link with multiple TRPs in a wireless communication system. The RF circuitry may comprise, for example, a transmitter and receiver configured to operate according to the 5G standards or other wireless communication standard. In exemplary embodiments, the RF circuitry includes two or more receiver chains for receiving signals transmitted from spatially separated TRPs.

The processing circuitry 430 comprises one or more microprocessors, hardware, firmware, or a combination thereof that control the overall operation of the UE 400. The processing circuitry 430 can be configured by software to perform the methods herein described including the methods 100, 150, and 200 shown in FIGS. 8-10 respectively.

Memory 440 comprises both volatile and non-volatile memory for storing computer program code and data needed by the processing circuitry 430 for operation. Memory 440 may comprise any tangible, non-transitory computer-readable storage medium for storing data including electronic, magnetic, optical, electromagnetic, or semiconductor data storage.

Memory 440 stores a computer program 450 comprising executable instructions that configure the processing circuit 430 in the UE 400 to perform the methods herein described including the methods 100, 150, and 200 shown in FIGS. 8-10 respectively. A computer program 450 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 450 for configuring the processing circuitry 430 as herein described may be stored in a removable memory, such as a portable compact disc, portable digital video disc, or other removable media. The computer program 450 may also be embodied in a carrier such as an electronic signal, optical signal, radio signal, or computer readable storage medium.

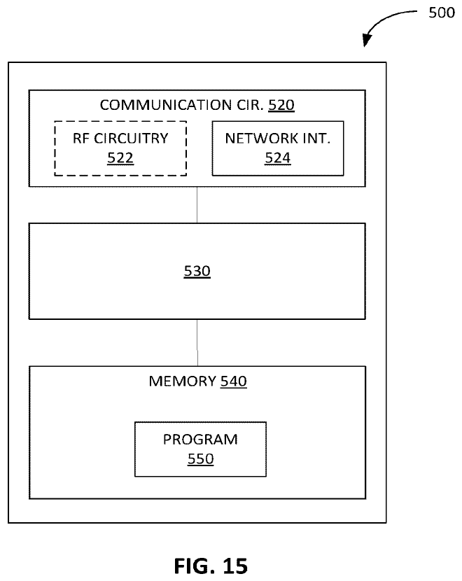

FIG. 15 illustrates the main functional components of a network node 500, which may comprise a base station, distributed unit, centralized unit, or other RAN node. The RAN node 500 comprises communication circuitry 520, processing circuitry 530, and memory 540.

In some embodiments, the communication circuitry 520 comprises both radio frequency (RF) circuitry 522 and network interface circuitry (NIC) 524. In other embodiments, the network node may comprise only NIC 424. The RF circuitry 422 can be located at one or more TRPs and comprises the RF components necessary for communicating with UEs over a wireless communication link. The RF circuitry may comprise, for example, a transmitter and receiver configured to operate according to the 5G standards or other wireless communication standard. The interface circuitry 520 comprises network interface circuitry for communication with other RAN nodes, core network nodes, and or external systems. The network interface circuitry may, for example, comprise an Ethernet interface, optical network interface, or a wireless interface.

The processing circuitry 530 comprises one or more microprocessors, hardware, firmware, or a combination thereof that control the overall operation of the RAN node 500. The processing circuitry 530 can be configured by software to perform one or more of the methods herein described including the methods 250, 300, and 350 shown in FIGS. 11-13 respectively.

Memory 540 comprises both volatile and non-volatile memory for storing computer program code and data needed by the processing circuitry 530 for operation. Memory 540 may comprise any tangible, non-transitory computer-readable storage medium for storing data including electronic, magnetic, optical, electromagnetic, or semiconductor data storage. Memory 540 stores a computer program 550 comprising executable instructions that configure the processing circuit 530 in the network node 500 to perform one or more of the methods herein described including the methods 250, 300, and 350 shown in FIGS. 11-13 respectively. A computer program 550 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 550 for configuring the processing circuitry 530 as herein described may be stored in a removable memory, such as a portable compact disc, portable digital video disc, or other removable media. The computer program 550 may also be embodied in a carrier such as an electronic signal, optical signal, radio signal, or computer readable storage medium.

Those skilled in the art will also appreciate that embodiments herein further include corresponding computer programs 440. A computer program 450-comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

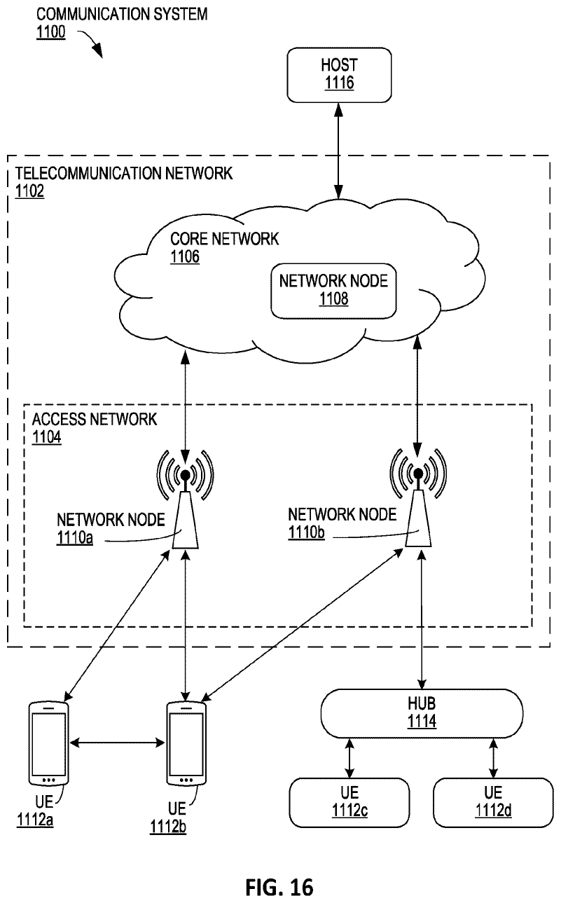

FIG. 16 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3rd Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

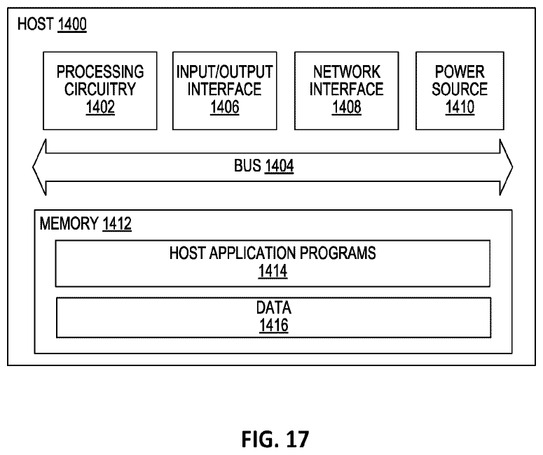

FIG. 17 is a block diagram of a host 1400, which may be an embodiment of the host 1116 of FIG. 16, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

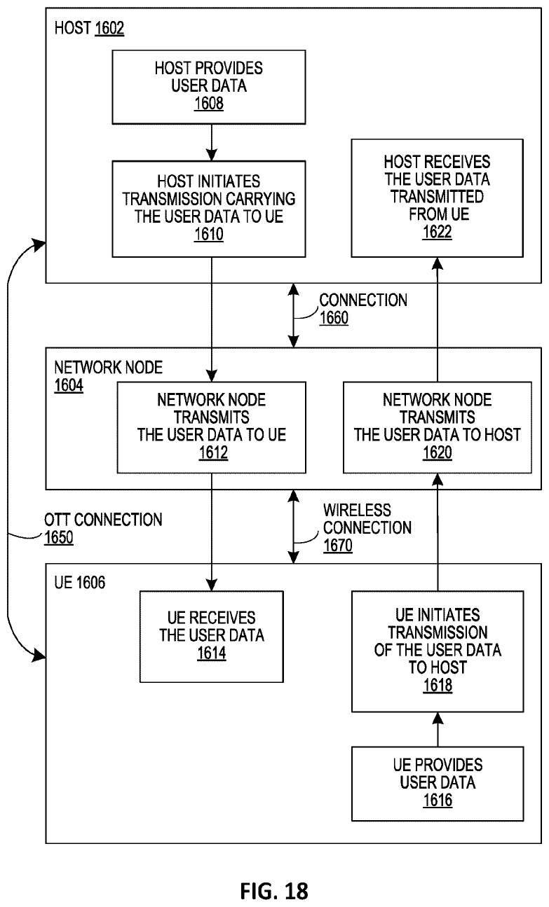

FIG. 18 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 16), network node (such as network node 1110a of FIG. 16), and host (such as host 1116 of FIG. 16) discussed in the preceding paragraphs will now be described with reference to FIG. 18.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 16) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606. One or more of the various embodiments improve the performance of OTT services provided to the UE 1606 using the OTT connection 1650, in which the wireless connection 1670 forms the last segment. More precisely, the teachings of these embodiments may enable the UE to conserve power resulting in longer battery life. In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

1-92. (canceled)

93. A method of reducing power consumption implemented by a user equipment (UE) having a wake up receiver (WUR), the method, comprising:
receiving a wake up signal (WUS) associated with a paging attempt from a network node; and
responsive to the paging attempt, sending WUR information to the network node, the WUR information comprising information related to WUR-based monitoring by the UE.

94. The method of claim 93, further comprising monitoring a paging channel responsive to receipt of the WUS;
wherein, the WUR information is sent to the network node responsive to successful decoding of a paging message transmitted on the paging channel.

95. The method of claim 93, wherein the WUS includes a paging indication to indicate to the network has data to send to the UE; and initiating a random access procedure responsive to the WUS.

96. The method of claim 93, wherein the WUR information is sent to the network node in a Medium Access Control (MAC) Control Element (MAC-CE) or the network node in a Radio Resource Control (RRC) message.

97. The method of claim 93, wherein the WUR information includes a signal quality of the received WUS, the signal quality comprises at least one of a WUR reference signal received power (RSRP), a WUR Reference Signal Received Quality (RSRQ), a WUR Channel Quality Indication (CQI), and a WUR Signal to Interference Plus Noise Ratio (SINR).

98. The method of claim 93, wherein the WUR information includes one or more performance metrics for the WUR;
wherein the performance metrics comprise at least one of a receiver noise level, a receiver sensitivity, and a receiver clock accuracy.

99. The method of claim 93, wherein the WUR information includes one more receiver parameters;
wherein the receiver parameters comprise at least one of a filter bandwidth, filter type, analog-to-digital conversion (ADC) parameter, sampling rate, active power, sleep power, and transition time between power states.

100. The method of claim 93, wherein the WUR information includes one or more receiver properties comprising at least one of a receiver type and a receiver performance class.

102. The method of claim 93, wherein the WUR information includes one or more configuration parameters;
wherein the configuration parameters comprise a discontinuous reception (DRX) parameter.

103. A user equipment (UE) having a wake up receiver (WUR), the UE comprising:
a processor and a memory, the memory containing instructions executable by the processor, whereby the UE is configured to:
receive a wake up signal (WUS) associated with a paging attempt from a network node; and
responsive to the paging attempt, send WUR information to the network node, the WUR information comprising information related to WUR-based monitoring by the UE.

104. The UE of claim 103, is further configured to monitor a paging channel responsive to receipt of the WUS;
wherein, the WUR information is sent to the network node responsive to successful decoding of a paging message transmitted on the paging channel.

105. The UE of claim 103, is further configured to initiate a random access procedure responsive to the WUS;
wherein the WUS includes a paging indication to indicate to the network has data to send to the UE.

106. The UE of claim 103, wherein the WUR information is sent to the network node in a Medium Access Control (MAC) Control Element (MAC-CE) or the network node in a Radio Resource Control (RRC) message.

107. The UE of claim 103, wherein the WUR information includes a signal quality of the received WUS, the signal quality comprises at least one of a WUR reference signal received power (RSRP), a WUR Reference Signal Received Quality (RSRQ), a WUR Channel Quality Indication (CQI), and a WUR Signal to Interference Plus Noise Ratio (SINR).

108. The UE of claim 103, wherein the WUR information includes one or more performance metrics for the WUR;
wherein the performance metrics comprise at least one of a receiver noise level, a receiver sensitivity, and a receiver clock accuracy.

109. The UE of claim 103, wherein the WUR information includes one more receiver parameters;
wherein the receiver parameters comprise at least one of a filter bandwidth, filter type, analog-to-digital conversion (ADC) parameter, sampling rate, active power, sleep power, and transition time between power states.

110. The UE of claim 103, wherein the WUR information includes one or more receiver properties comprising at least one of a receiver type and a receiver performance class.

111. The UE of claim 103, wherein the WUR information includes one or more configuration parameters;
wherein the configuration parameters comprise a discontinuous reception (DRX) parameter.

112. A non-transitory computer-readable medium storing a computer program product for controlling a user equipment (UE), the computer program product comprising software instructions that, when run on the programmable network entity, cause the UE to:
receive a wake up signal (WUS) associated with a paging attempt from a network node; and
responsive to the paging attempt, send WUR information to the network node, the WUR information comprising information related to WUR-based monitoring by the UE.

113. The non-transitory computer-readable medium of claim 112, further causes the UE to monitor a paging channel responsive to receipt of the WUS;
wherein, the WUR information is sent to the network node responsive to successful decoding of a paging message transmitted on the paging channel.
